(19) United States
(12) Patent Application Publication
(10) Pub. No.: US 2004/0131835 A1
(43) Pub. Date: Jul. 8, 2004

(54) Structure for heat dissipation

(75) Inventors: Theodore Nicolas Schmitt, Wien (AT); Klaus Dieter Mauthner, Grafenstein (AT); Ernst Hammel, Wien (AT)

Correspondence Address: HENRY M FEIEREISEN, LLC, 350 FIFTH AVENUE, SUITE 4714, NEW YORK, NY, 10118, US

(73) Assignee: ELECTROVAC, FABRIKATION ELEKTROTECHNISCHER SPEZIALARTIKEL GESELLSCHAFT M.B.H., Klosterneuburg (AT)

(21) Appl. No.: 10/706,864

(22) Filed: Nov. 12, 2003

(30) Foreign Application Priority Data
Nov. 12, 2002 (AT) A 1705/2002

(51) Int. Cl. B32B 5/00

(52) U.S. Cl. 428/293.1; 428/614; 428/293.4; 428/297.4

(57) ABSTRACT

A heat dissipating structure includes a composite having a thermal expansion coefficient between 30° C. and 250 ° C. in a range from 2 to 13.10⁻⁶ K⁻¹, a volume mass below 3000 kg·m⁻³, and a conductivity equal to or greater than 113 W·m⁻¹·K⁻¹. The composite is formed by a matrix which is made of a metal, polymer, or resin, in combination with a reinforcement component. The reinforcement component contains microfibers at a volume proportion in a range from 5 to 90% and nanofibers at a volume proportion from 1 to 60%, with the composite obtained through infiltration of the reinforcement component by the metal in liquid state or the polymer and resin in liquid or uncured state. Applied onto the composite is a surface layer having entirely or at least partially a metallic character.

### CROSS-REFERENCES TO RELATED APPLICATIONS

This application claims the priority of Austrian Patent Application, Serial No. A 1705/2002, filed Nov. 12, 2002, pursuant to 35 U.S.C. 119(a)-(d), the disclosure of which is incorporated herein by reference.

### BACKGROUND OF THE INVENTION

The present invention relates, in general, to a structure for heat dissipation.

Composites are widely used as construction material in areas that require high mechanical strength and smallest possible weight, e.g. in aircraft construction or sporting goods. In addition, composites find wide application in the electronics industry as carrier substrates because the individual composites can be best suited to the application at hand as far as mechanical properties are concerned and, more importantly, as far as thermal properties are concerned. Normally, a composite is made of a ductile matrix component, e.g. a metal or an organic polymer, and a fill component which has a different structure than the matrix.

The article “Materials for Thermal Conduction” by Chung et al. Appl. Therm. Eng., 21, (2001) pages 1593-1605, provides an overview about materials for heat conduction and heat dissipation and illustrates properties of possible individual components and relevant examples for composites. Ting et al. describes in J. Mater. Res., 10 (6), 1995, pages 1478-1484 the production of aluminum VGCF (Vapor Grown Carbon Fiber) composites and their heat conducting properties. U.S. Pat. No. 5,814,408 to Ting et al, based on the article by Ting et al., describes an aluminum matrix composite which includes a perform of graphitized vapor grown carbon fibers. Composites with carbon fibrils, a defined CVD carbon fiber in a metal matrix as well as polymer matrix, is described in U.S. Pat. No. 5,578,543 to Hoch et al. U.S. Pat. No. 6,406,709 to Ushijima describes the manufacture of a composite with CVD grown carbon fibers as filler through pressure filtration of the matrix metal. U.S. Pat. No. 6,469,381 to Houle et al. describes a semiconductor element which dissipates heat into the carrier plate through incorporation of carbon fibers. The use of coated carbon fibers in composites with metallic matrix is disclosed in U.S. Pat. No. 5,660,923. The inclusion of Al₂O₃ fibers in an aluminum matrix and the manufacture of the respective fiber-reinforced composites are disclosed in U.S. Pat. No. 6,460,597 to McCullough et al.

Structures for heat dissipation involve, e.g., heat dissipation bases, carriers and pole pieces of power circuits, laser diode carriers, heat dissipation members and encapsulation housings of hybrid circuits of power microelectronics, or hyper frequency circuits. Also included here are cooling units, e.g. water-circulated micro-cooling devices, heat sinks on circuit boards, heat pipes or the like. In the electronic field, the structures involved here are connected for heat dissipation to insulating substrates of ceramics, such as e.g. aluminum oxide or with semiconductors such as e.g. silicon or gallium arsenide. Operation of such electronic components may result is a significant generation of heat so that a rapid dissipation of heat is necessary to prevent excessive heating. Therefore, the use of a composite of high heat conductivity λ of at least above 60 W·m⁻¹·K⁻¹ is proposed. However, the encountered temperature is still elevated, and in the event the expansion coefficient α of the composite is different enough from the ceramic substrate, the latter is exposed to mechanical stress that ultimately may lead to fractures so that the conductivity of the arrangement and their electric insulation are adversely affected. Therefore, the composite should have an expansion coefficient that is compatible with aluminum oxide, e.g. below 16.10⁻⁶ K⁻¹ in the temperature range of 30-400° C.

On the other hand, a potential use of such switching circuits in motor vehicles makes it necessary to find materials that have a lowest possible volume mass, preferably less than 3000 kg·m⁻³, to reduce the energy consumption during travel. Moreover, as the switching circuits are sensitive to the environment, the material should exhibit a suitable amagnetic character as well as a good sealing capability against the external medium.

There have been many attempts to manufacture a material that reconciles all these characteristics. The use of a fiber-reinforced composite does, however, not allow to firmly anchor electronic components. In particular carbon which is present on the original surface as a consequence of the manufacturing process, prevents the attachment of switches, transistors and the like, because carbon from metals or alloys, as used as solder in the electronics field, are not wetted. In the case of Al or its alloys, auto passivation of the aluminum as a consequence of oxide formation on the surface impairs the direct attachment of the electronic components onto the heat dissipating substrate.

It would therefore be desirable and advantageous to provide an improved structure for heat dissipation to obviate prior art shortcomings.

### SUMMARY OF THE INVENTION

According to one aspect of the present invention, a heat dissipating structure includes a composite having a thermal expansion coefficient between 30° C. and 250° C. in a range from 2 to 13.10⁻⁶ K⁻¹, a volume mass of less than 3000 kg m⁻³, and a conductivity equal to or greater than 113 W·m⁻¹·K⁻¹, wherein the composite includes a matrix component, which is made of metal, polymer, or resin, and a reinforcement component, which contains microfibers at a volume proportion in a range from 5 to 90% and nanofibers at a volume proportion from 1 to 60%, wherein the composite is obtained through infiltration of the reinforcement component with the matrix component, and a surface layer applied onto the composite and having entirely or at least partially a metallic character.

The present invention resolves prior art problems by applying an additional surface layer upon the heat-dissipating composite after its production and/or processing. The metallic surface layer adheres well and allows application of any conventional mounting process, on the one hand, while providing the heat-dissipating composite on a metal matrix base with a sufficient protection against corrosion, on the other hand. In case of metal-bound composites, the corrosive attack of moist air, acidic or basic mist and reactive gases is prevented. Polymer-infiltrated substrate materials are further protected by the metallic surface layer according to the invention against organic agents, e.g. oil mist, halogenated solvents. The additional surface layer according to the invention allows attachment of electronic components, e.g. through soldering, and sufficiently protects the substrate material against corrosion.

According to another feature of the present invention, the metal for the matrix component may be selected from pure aluminum, pure magnesium, pure copper, and alloys thereof. The matrix may also be made of a copper-tungsten composition or copper-molybdenum composition.

According to another feature of the present invention, the surface layer may be made of metal or a metal alloy, e.g. Ni, Cu, Au, Ag, Ti, Al, V, Mo, or W, or alloys thereof. Thus, application of the surface layer can be implemented by any conventional coating processes available, e.g. electrochemical process, chemical process, and/or physical process.

According to another feature of the present invention, the surface layer may be made entirely, or at least partially, of Ni, Ni—B, Ni—P, and NI-alloys. These materials are characterized by a particularly good adhesiveness to composites. Tests have shown that the adhesiveness of the surface layer is superior when the surface layer is applied at a thickness of few nanometers to few millimeters, preferably at a thickness of few microns.

According to another feature of the present invention, the surface layer may be textured, e.g. through an etching process. The metallic character of the surface layer is hereby conducive to this process.

According to another feature of the present invention, the composite may contain carbon fibers at an amount from 5 to 90% at a diameter which is greater than 1 μm, suitably 5 to 15 μm. In this way, the bonding properties of the composite can be positively affected. Of course, the carbon fibers may be realized in various manner. One option may involve manufacture of the carbon fibers from graphitized polyacryinitrile and/or pitch. The carbon fibers may be incorporated in the metal matrix one-dimensional or in the form of a two-dimensional or three dimensional network.

According to another feature of the present invention, the composite may contain microfibers at an amount of 1 to 90% at a diameter of less than 5 μm. The composite may, however, contain also nanofibers at an amount of 1 to 60% at a diameter of less than 1 μm. Nanotubes, which are part of the family of nanofibers, are cylindrical single-layer or multi-layer carbon tubes at a diameter from 1-30 nm. With the assistance of nanotubes, a microstructure or nanostructure of the composite can be realized, leading to a greater active volume that significantly improves the heat conductivity. Furthermore, as a consequence of their superior mechanical properties, nanotubes ensure a sufficient stability of the material while still allowing the material to be easily processed.

According to another feature of the present invention, the composite may contain 1 to 60% of nanofibers, such as carbon nanofibers, at a diameter of less than 300 nm. In this way, the composite exhibit improved mechanical and thermal properties. Suitably, the carbon nanofibers are obtained through catalyst-supported extraction of carbon from a gas phase. A superior heat conductivity may be realized, when the carbon nanofibers have a hollow inner channel.

According to another feature of the present invention, the carbon nanofibers may contain in addition to carbon also boron and/or nitrogen, thereby improving the heat conductivity. Suitably, the composite may contain boron nanofibers or BN-nanofibers at an amount of 1 to 60% and at a diameter of less then 300 nm.

Another option to enhance the strength and heat conductivity of the composite involves a composite which contains 1 to 60% of nanofibers sized at a diameter of less than 300 nm and made of a material selected from the group consisting of MoS₂, WS₂, NbS₂, TaS₂, and VₛO₅, in the form of multi-walled nanotubes. Still another approach to enhance the thermal conductivity involves a composite which contains 1 to 60% of nanofibers made of a single atomic layer in the shape of a tube. An improved heat conductivity and improved mechanical strength may also be realized by providing a composite which contains 1 to 90% of microfibers sized at a diameter of greater than 1 μm and made of glass or ceramics. Suitably, the mircofibers of glass or ceramics have a continuous metallic layer.

A structure according to the present invention can be used in many ways for heat dissipation, e.g. as a cooling element circulated by a liquid to further improve a dissipation of heat, or as heat pipe or coupled to a heat pipe. The structure may be provided with cooling ribs through which a gas circulates, to thereby allow a cooling action e.g. by means of the ambient air. The structure may also be configured as part of an electronic component, e.g. chip cover, base for an IGBT, base for a thyristors, base for a laser diode, electronic casing, hermetically sealed casing. Another application of the structure is configured as a carrier or construction material and is able to withstand changing loads.

According to another feature of the present invention, it is also possible, to pour a matrix metal poured about the metal matrix component of the composite core.

### BRIEF DESCRIPTION OF THE DRAWING

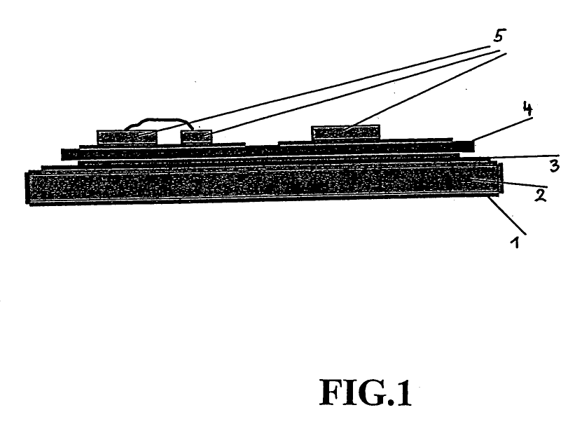

Other features and advantages of the present invention will be more readily apparent upon reading the following description of currently preferred exemplified embodiments of the invention with reference to the accompanying drawing, in which the sole FIG. 1 is a side view of one embodiment of a structure according to the present invention.

### DETAILED DESCRIPTION OF PREFERRED EMBODIMENTS

The depicted embodiment is to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to FIG. 1, there is shown a side view of one embodiment of a structure according to the present invention, including a composite 2 for effecting a heat dissipation of heat generated by attached electronic components during operation as a consequence of loss power. Applied onto the composite 2 is a surface layer 1 which exhibits entirely or at least partially a metallic character. The surface layer 1 may cover the composite 2 completely or at least partially and improves thereby the adhesiveness of the composite 2. Thus, a solder layer 3 can, for example, be applied and adhere to the surface layer 1 for realizing a rigid attachment of electronic components 5. In the non-limiting example of FIG. 1, a DCB (Direct Copper Bonding)-substrate 4 is arranged between the electronic components 5 and the surface layer to ensure a secure and thermally well-conducting connection layer. Of course, it is conceivable to directly solder the electronic components 5 to the surface layer 1.

The composite 2 has, at least in two directions, an expansion coefficient α between 30° C. and 250° C. in the range from 2 to 13.10⁻⁶ K⁻¹, a volume mass of less than 3000 kg·m⁻³, and a conductivity λ equal to or greater than 113 W·m⁻¹·K⁻¹, and has a matrix component made of metal, such as pure aluminum, pure magnesium, pure copper and alloys thereof, or made of polymers or resins, and a reinforcement component made of a felt or a preform of microfibers at a volume proportion in the range of 5 to 90% and nanofibers at a volume proportion in the range of 1 to 60%. The composite 2 is hereby produced through infiltration of the reinforcement component with the matrix component, i.e. metal in liquid state, or polymers or resins in plasticized or non-cured state.

Hollow spaces of the felt or preform are filled in an optimum manner with carbon fractions in the form of nanotubes with formation of an optimum micro/nanostructure. The metallic matrix which contains the particles and, optionally, fibers as well as nanofibers, may be made of pure aluminum, pure magnesium, pure copper and alloys thereof. These metals ensure a good conductivity, a low density, and a low melting point. When using aluminum alloys, few alloying constituents should be contained therein. Zinc, copper, magnesium, iron and nickel may be tolerated in small quantities. Manganese, titanium, vanadium and lithium should be avoided. Suitably, alloys are used of series 1000, 5000 and 6000 according to the standards established by the Aluminium Association, as well as cast alloys of series 4000, in particular cast alloys that contain 7, 10 and 13% of silicon, such as e.g. alloys AA 356, AA 357, AA 413.2, and alloys of series 6000, such as alloys 6061 and 6101. Examples of fiber-reinforced, heat dissipating, polymer-bound matrix materials include thermoplastic material such as PET (polyethyleneterephthalate), PMMA (polymethylmethacrylate), PC (polycarbonate), PA (polyamide), etc, and duroplastic material such as PUR (polyurethane), PF (phenol formaldehyde resin), MF (melamine formaldehyde resin), EP (epoxy resin), etc. Manufacture of nanotubes/nanofibers may be realized according to the CCVD process (catalytical chemical vapor deposition), although other process are certainly applicable as well. The CCVD process is currently preferred because sufficient quantities of material can be produced for technical applications.

The surface layer 1 is made of metal or metal alloy, whereby the metal or metal alloy are preferably made of Ni, Cu, Au, Ag, Ti, Al, V, Mo, W, and alloys thereof. Of course, it is also possible to make the surface layer 1 entirely or at least partially of Ni, Ni—B, Ni—P and Ni-alloys.

The process for applying the surface layer 1 may include an electrochemical process, chemical process, or physical process, in particular sputtering and roll-bonded cladding. The surface layer 1 may be applied at a layer thickness of few nanometers up to few millimeters, and may be textures, e.g. through etching.

In the following, various examples are given for constituents of the composite 2:

### EXAMPLE 1

5 to 90% of carbon fibers at a diameter of greater than 1 μm.

### EXAMPLE 2

5 to 90% of carbon fibers at a diameter of 5 to 15 μm. The carbon fibers may contain boron and/or nitrogen in addition to carbon.

### EXAMPLE 3

1 to 90% of microfibers at a diameter of less than 5 μm.

### EXAMPLE 4

Carbon fibers made of graphitized polyacryinitrile and/or pitch.

### EXAMPLE 5

1 to 60% of nanofibers at a diameter of less than 1 μm.

### EXAMPLE 6

1 to 60% of nanofibers at a diameter of less than 300 nm.

### EXAMPLE 7

1 to 60% of carbon nanofibers sized at a diameter of less than 300 nm and obtained through catalyst-supported extraction of carbon from a gas phase. The carbon nanofibers may be formed with a hollow inner channel.

### EXAMPLE 8

1 to 60% of boron nanofibers or BN nanofibers at a diameter of less than 300 nm.

### EXAMPLE 9

1 to 60% of nanofibers at a diameter of less than 300 nm and made of a material selected from the group consisting of MOS₂, WS₂, NbS₂, TaS₂, and VₛO₅, in the form of multi-walled nanotubes.

### EXAMPLE 10

1 to 60% of nanofibers with the fibers being made of a single atomic layer in the shape of a tube.

### EXAMPLE 11

1 to 90% of microfibers sized at a diameter of greater than 1 μm and made of glass or ceramics.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A heat dissipating structure, comprising:
a composite having a thermal expansion coefficient between 30° C. and 250° C. in a range from 2 to 13.10⁻⁶ K⁻¹, a volume mass of less than 3000 kg·m³, and a conductivity equal to or greater than 113 W·m⁻¹·K⁻¹, said composite including a matrix component made of a material selected from the group consisting of metal, polymer, and resin, and a reinforcement component, which contains microfibers at a volume proportion in a range from 5 to 90% and nanofibers at a volume proportion from 1 to 60%, wherein the composite is obtained through infiltration of the reinforcement component with the matrix component; and
a surface layer applied onto the composite and having entirely or at least partially a metallic character.

2. The structure of claim 1, wherein the matrix component is metal and infiltrates the reinforcement component in liquid state, or the matrix component is polymer or resin in liquid or uncured state for infiltrating the reinforcement component.

3. The structure of claim 1, wherein the metal is selected from the group consisting of pure aluminum, pure magnesium, pure copper, and alloys thereof.

4. The structure of claim 1, wherein the matrix is made of a copper-tungsten composition or copper-molybdenum composition.

5. The structure of claim 1, wherein the surface layer is made of metal or a metal alloy.

6. The structure of claim 1, wherein the metal or metal alloy is made of a material selected from the group consisting of Ni, Cu, Au, Ag, Ti, Al, V, Mo, W, and alloys thereof.

7. The structure of claim 1, wherein the surface layer is made entirely, or at least partially, of a material selected from the group consisting of Ni, Ni—B, Ni—P, and NI-alloys.

8. The structure of claim 1, wherein the surface layer is applied by at least one process selected from the group consisting of electrochemical process, chemical process, and physical process.

9. The structure of claim 1, wherein the surface layer is applied by an electrochemical process.

10. The structure of claim 1, wherein the surface layer is applied by sputtering.

11. The structure of claim 1, wherein the surface layer is applied by roll-bonded cladding.

12. The structure of claim 1, wherein the surface layer is applied at a thickness of few nanometers to few millimeters.

13. The structure of claim 1, wherein the surface layer is applied at a thickness of few microns.

14. The structure of claim 1, wherein the surface layer is textured.

15. The structure of claim 14, wherein the surface layer is textured through an etching process.

16. The structure of claim 1, wherein the composite contains 5 to 90% of carbon fibers at a diameter of greater than 1 μm.

17. The structure of claim 1, wherein the composite contains 5 to 90% of carbon fibers at a diameter of 5 to 15 μm.

18. The structure of claim 1, wherein the composite contains 1 to 90% of microfibers at a diameter of less than 5 μm.

19. The structure of claim 16, wherein the carbon fibers are made of at least one material selected from the group consisting of graphitized polyacryinitrile and pitch.

20. The structure of claim 16, wherein the carbon fibers are incorporated in the matrix one-dimensional or in a form of a two-dimensional or three dimensional network.

21. The structure of claim 1, wherein the composite contains 1 to 60% of nanofibers at a diameter of less than 1 μm.

22. The structure of claim 1, wherein the composite contains 1 to 60% of nanofibers at a diameter of less than 300 nm.

23. The structure of claim 1, wherein the composite contains 1 to 60% of carbon nanofibers sized at a diameter of smaller than 300 nm and obtained through catalyst-supported extraction of carbon from a gas phase.

24. The structure of claim 23, wherein the carbon nanofibers have a hollow inner channel.

25. The structure of claim 23, wherein the carbon nanofibers contain at least one element selected from the group consisting of boron and nitrogen in addition to carbon.

26. The structure of claim 1, wherein the composite contains 1 to 60% of a material selected from the group consisting of boron nanofibers or BN-nanofibers at a diameter of less then 300 nm.

27. The structure of claim 1, wherein the composite contains 1 to 60% of nanofibers sized at a diameter of less than 300 nm and made of a material selected from the group consisting of MOS₂, WS₂, NbS₂, TaS₂, and VₛO₅, in the form of multi-walled nanotubes.

28. The structure of claim 1, wherein the composite contains 1 to 60% of nanofibers made of a single atomic layer in the shape of a tube.

29. The structure of claim 1, wherein the composite contains 1 to 90% of microfibers sized at a diameter of greater than 1 μm and less than 5 μm, and made of glass or ceramics.

30. The structure of claim 29, wherein the microfibers have a continuous metallic layer.

31. The use of a structure according to claim 1 for heat separation.

32. The structure of claim 1, and further comprising a cooling element attached to the structure and circulated by a liquid.

33. The structure of claim 1, configured as a cooling element through which a liquid circulates.

34. The structure of claim 1, configured as heat pipe.

35. The structure of claim 1, configured as attachment to a heat pipe.

36. The structure of claim 1, wherein the structure is provided with cooling ribs through which a gas circulates.

37. The structure of claim 1, configured as a chip cover.

38. The structure of claim 1, configured as a base plate for an IGBT.

39. The structure of claim 1, configured as a base plate for a thyristors.

40. The structure of claim 1, configured as a base plate for a laser diode.

41. The structure of claim 1, configured as an electronic casing.

42. The structure of claim 1, configured as a hermetically sealed casing.

43. The structure of claim 1, configured as a carrier or construction material and able to withstand changing thermal loads.

44. The structure of claim 1, and further comprising a matrix metal poured about the composite having a core of metal matrix.
